(19) United States
(12) Patent Application Publication
(10) Pub. No.: US 2003/0221122 A1
(43) Pub. Date: Nov. 27, 2003

(54) Autonomic security settings switching based upon a network connection security profile

(75) Inventor: Masahiko Hatori, Ebina-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/417,626

(22) Filed: Apr. 17, 2003

(30) Foreign Application Priority Data
Apr. 18, 2002 (JP) 2002-116768

(51) Int. Cl. G06F 12/14; G06F 11/30; H04L 9/32; H04L 9/00

(52) U.S. Cl. 713/200

(57) ABSTRACT

A system is provided for a user to safely use a computer apparatus in places where securities are not assured. In a notebook type computer apparatus enabling external transmission via a predetermined network connection among a plurality of network connections, security information is set in association with a network connection to be used by a security setting and recording device by a user operation with an input device; the security information set by the security setting and recording device is stored in a security information database; security switching device controls a file sharing service based on the security information stored in the security information database such that accesses from other network connected computers to shared file resources is terminated.

### BACKGROUND OF THE INVENTION

The present invention relates to a computer performing external communication, more particularly, to a computer enhancing a security level when connecting to a network.

Computer apparatuses such as notebook personal computers (notebook PCs) are capable of connecting to networks such as LAN (local 1251area network) through interface devices that are referred to as a NIC (network interface card) or a LAN adaptor. As the interfaces to be connected to networks, modems have been mainly used, and today mainly used are wired communication adapters such as token-ring adapters and Ethernet adapters. Further, the use of wireless LAN adapters as the interface is going to be common. Thus, a single computer apparatus requires to have a number of interface devices. When a single computer apparatus is provided with a number of interface devices in this way, its user can have access via various networks, for example, while carrying a notebook PC.

As described above, access via various networks becomes available. However, security measures are required depending on the reliability levels of the lines respectively, since the reliability level of security of line depends on destinations to be connected. For example, when connecting to an intranet in a company, a low security protection level is not an important issue, since the line is sufficiently reliable and therefore relatively safe. On the other hand, when connecting to Internet via an ISP (Internet service provider) from home, a certain level of security protection is required because of a possibility of being attacked by a hacker/cracker or an attacker. Furthermore, a higher level of security protection is required in the case of connection to Internet from a public place such as a hotel, or connection to Internet from a wireless hot spot in a coffee shop. Such cases occur more often recently, and then the reliability of the lines is substantially zero.

One of the most important security measures required for each of such network connections is security protection for file sharing. On a notebook PC, files are usually shared via a network for use because of its limited drive bay. For example, a case is expected to often occur in which file sharing is set up on a notebook PC in a safe place such as a company, and then the notebook PC is used for network connection in a public place with the file sharing set up. In this case, files set to be shared can still be accessed from other computer apparatuses connected to the network. That is, if a user connects to a public network without changing the security setup performed in his company such as file sharing setup, a possibility occurs that his files are viewed by others thereby resulting in data leak.

To avoid this risk, it is desirable to turn off file sharing whenever connecting to a network having security problems. In order to change the setup that permits file sharing via networks, a user is required to change settings of all the shared drives and folders (sharing can be set up for each folder individually) through a standard setting screen provided by the operating system. By changing the settings, an access control list included in the operating system is updated so that a file system can control the determination whether or not to permit access to folders and files based on the access control list when any access thereto is attempted via a network. This setup change, however, must be made for a lot of setting items and is very troublesome. Furthermore, the user is required to perform the exactly opposite operation when he comes back to his company and wants to restore the changed settings to the original condition. That is, it is required to change the file sharing setup for complicated items every time the user moves his notebook PC. It is undesirable to force the user to perform such complicated operations.

The present invention is intended to solve the technological problem as described above. A purpose of the invention is to enable a user to use a computer apparatus even where security is not ensured.

Another purpose is to prohibit, for example, file sharing and program download by easy operations or automatically.

Still another purpose is to control file sharing more certainly than in the case of controlling individually.

Still another purpose is to easily restore prohibited file sharing to the original condition.

### SUMMARY OF THE INVENTION

To achieve the above purposes, the present invention uses particularly “file sharing service” in which the sharing of files are executed in background and the file sharing service is temporary terminated when a user intends to turn off the file sharing service, and when the user intends to turn on the file sharing service, the temporal termination is canceled. The above feature makes it possible to realize a concentrated control of prompt file sharing without caring about share settings which are provided with each of drives and folders. That is, the present invention provides a computer apparatus enabling external transmission via a predetermined network connection among a plurality of network connections, the computer apparatus terminates an access control program for controlling file accesses from other network connected computers by a termination means and starts the access control program terminated by said termination means.

If the computer apparatus further comprises network recognizing means for recognizing a network to be connected, the termination means terminates the access control program based on the network recognized by the network recognizing means, and the network recognizing means recognizes a network based on a profile associated with a connectable network, then it is preferable because file sharing can be controlled as the network is connected.

The termination means and/or the starting means may be characterized in terminating and/or starting the access control program based on a user specification. The user specification includes that performed by setting security information each time he sets up a network, as well as that performed by presetting a security level (security information) in association with a location at which network connection is set up, such as “office”, “home”, “hotel”, and “coffee shop” , for example.

According to the present invention, a computer apparatus sets security information in association with a network connection to be used using security information setting means; stores the security information set by the security information setting means using security information storing means; and disables processes to be performed by other network connected computers using security switching means based on the security information stored in the security information storing means.

The processes stopped by the security switching means may be characterized in being related to file/printer sharing, or download of a program to be downloaded via a network and/or execution thereof.

In another aspect of the invention, a computer apparatus comprises: a file sharing service for controlling file accesses from other network connected computers to folders and/or drives individually set to be shared; and a switching device for directing stop or start of the file sharing service. The switching device is characterized in directing stop or start of the file sharing service based on a user instruction. The switching device is also characterized in directing stop or start of the file sharing service depending on a network to be connected.

In still another aspect of the invention, there is provided portable information equipment, such as a notebook PC or a PDA (personal digital assistant), enabling external transmission via a network to be connected at a place to which it moves, the portable information equipment comprising: setting means for setting whether or not to permit file sharing against the network; termination means for stopping accesses to shared files from other computer apparatuses via networks based on the setting provided by the setting means, whether or not sharing of each of individual drives and folders is permitted; and starting means for starting file sharing stopped by the termination means.

These termination means and/or starting means may be characterized in performing network setting work based on detection of a network at a place to which the equipment has moved and stopping and/or starting file sharing when performing the network setting work. This setting means is also characterized in setting up a profile associated with the network.

The present invention provides a security switching method to be performed on a computer apparatus enabling external transmission via a predetermined network connection among a plurality of network connections, comprising the steps of: terminating an access control program for controlling file accesses from other network connected computers; and starting execution of the stopped access control program.

The step of terminating the access control program terminates the access control program based on a user setting or automatically, whether or not each folder or each drive is permitted to be shared, to prohibit file sharing with the other computers. The step of starting execution of the access control program permits file sharing with the other computers, which has been stopped, based on preset sharing setup without providing new sharing setup for each folder or for each drive.

According to the present invention, a security switching method comprise the steps of: setting security information in association with a network connection to be used; storing the set security information; and disabling processes to be performed by other network connected computers based on the stored security information. The step of disabling the processes to be performed by the other computers is for disabling processes related to sharing of files and printers and/or processes related to a program to be downloaded via a network.

Furthermore, the present invention provides a program for causing a computer enabling external transmission via a predetermined network connection among plurality of network connections to implement the functions of: terminating an access control program for controlling file accesses from other network connected computers; and starting execution of the stopped access control program. There is also provided a program for causing a computer to implement the functions of: setting security information in association with a network connection to be used; storing the security information in a predetermined memory; and disabling processes to be performed by other network connected computers based on the stored security information.

These programs to be executed by a computer may be stored on a storage medium the computer can read. Such storage medium includes, for example, a CD-ROM medium, and the programs may be read therefrom by a CD-ROM reading device provided for a computer, and stored in one of various types of memories, such as a hard disk, provided for the computer, and then executed. Furthermore, these programs may be provided for a computer apparatus, such as a notebook PC, and portable information equipment by a program transmitting device via a network, for example. In this case, any program transmitting device is sufficient only if it is equipped with a memory for storing the programs therein and program transmitting means for providing the programs via a network.

The above summary of the invention does not enumerate all of the necessary features for the present invention, but some combinations of these features may be also inventive features.

### BRIEF DESCRIPTION OF THE DRAWINGS

Some of the purposes of the invention having been stated, others will appear as the description proceeds, when taken in connection with the accompanying drawings, in which:

FIG. 1 shows a general configuration of a system according to the embodiment of the present invention;

FIG. 2 is a block diagram illustrating functions of a switching device;

FIG. 3 shows a flowchart illustrating a main process in switching of security;

FIG. 4 shows a flowchart illustrating the process of setting up file/printer sharing in changing the security setting at step 104 shown in FIG. 3;

FIG. 5 shows a flowchart illustrating the processes of setting up ActiveX, Java and Java Script in changing the security setting at step 104 shown in FIG. 3;

FIG. 6 shows a flowchart illustrating the process of setting up file download/execution in changing the security setting at step 104 in FIG. 3;

FIG. 7 shows an example of a setting screen to be displayed on an output device when security is set up in a security setting and recording device;

FIG. 8 shows an application of a system according to the embodiment of the present invention;

FIGS. 9(a) and 9(b) illustrate a network name (SSID) detection method; and

FIG. 10 shows a flowchart illustrating the process of switching location profiles.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

The present invention will be described in detail with respect to an embodiment thereof with reference to the accompanying drawings.

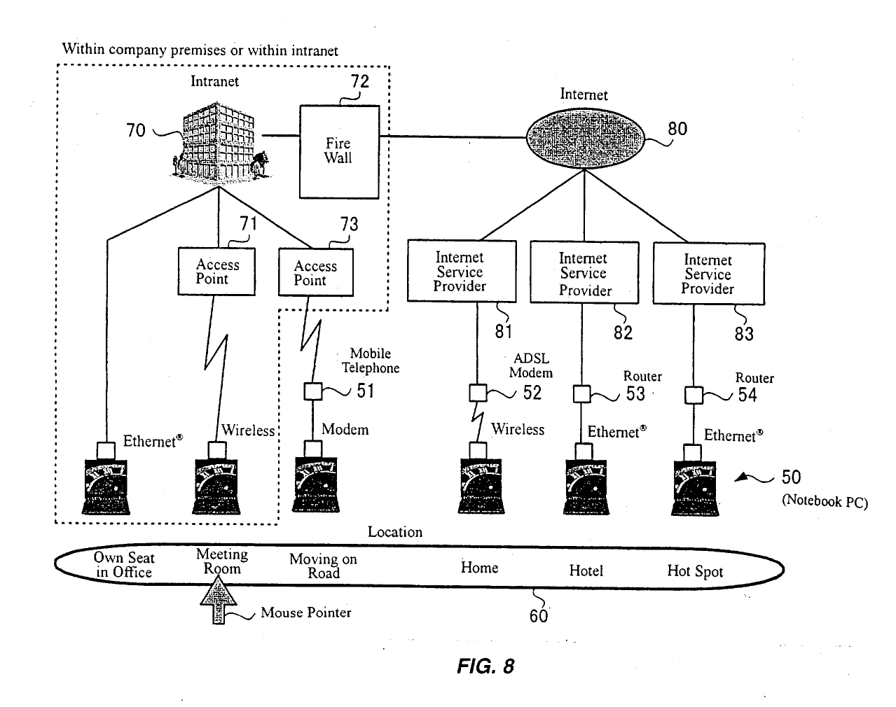

Referring now more particularly to the accompanying drawings, FIG. 8 shows an application of a system according to the embodiment of the present invention. The figure shows the circumstances in which a notebook personal computer apparatus (notebook PC) 50 is used while moving to various places. Switching of network connections in the notebook PC 50 is performed by specifying a location in a location display 60 using, for example, a mouse pointer. The term “network connection” used herein includes connection setup for connecting a hardware (HW) interface to a network, and setup for an application program and a browser required for connection, for example.

FIG. 8 shows a location display 60 showing locations of Own Seat in Office, Meeting Room, Moving on Road, Home, Hotel, and Hot Spot. A user is enabled to switch both an interface and connection setup at the same time in order to switch network connection without complicated operations (interface switching and connection setup switching) at a place to which he has moved, only by selecting a preset location name using a mouse pointer, for example. Furthermore, according to the embodiment of the present invention, security information for each of the locations is provided as a profile, so that contents related to various securities are also set when a network connection is setup by specifying one of the locations.

FIG. 8 shows a case where the notebook PC 50 is connected to an intranet 70 and to Internet 80. Between the intranet 70 and Internet 80, there is provided a fire wall 72 for controlling data communication. Within the company premises shown by a broken line or within the intranet 70 in the figure, there is provided an access point 71 serving as a radio wave receiving point for wireless communication. When the notebook PC 50 is switched to its wireless adapter, it is connected directly to the access point 71, and when switched to its modem adapter, it is connected to an access point 73 via a mobile telephone 51. When connecting to Internet 80 not via the intranet 70, the notebook PC 50 is connected thereto via one of Internet service providers 81 to 83. The notebook PC 50 is connected from the home Ethernet(not shown) or wireless network to the Internet service provider 81 through an ADSL (Asymmetric Digital Subscriber Line) modem 52, and is connected from the wireless and Ethernet adapters provided therein to the Internet service providers 82, 83 via routers 53, 54, respectively.

In the case of connecting to the intranet 70 from each location of Own Seat in Office, Meeting Room, and Moving on Road in the location display 60 shown in FIG. 8, the security protection level may be low because the lines are relatively sufficiently reliable. In the case of connecting to Internet 80 from home through the ADSL modem 52 and then via the Internet service provider 81, the safety level is middle and a certain level of security is required. As for connection to Internet from a public place, such as a hotel and a wireless hot spot, for example, reliability of the lines is substantially zero and a high level of security protection is required. Thus, according to the embodiment of the present invention, the notebook PC 50 is so configured that a higher security level is set by the user (in network setup work, for example) or automatically (by recognizing a network to be connected, for example) when it has moved to a wireless hot spot, for example.

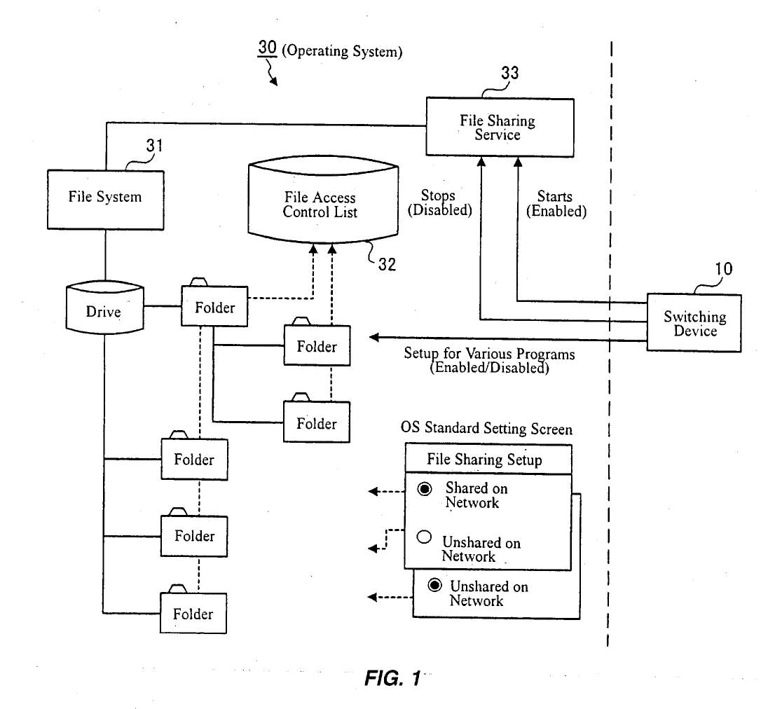

FIG. 1 illustrates a general configuration of a system according to the embodiment of present invention. The system is provided with a switching device 10 comprising software for switching on/off of file/printer sharing and on/off of file download/execution against an operating system (OS) 30, the basic software to be installed on the notebook PC 50, for example.

The operating system 30 comprises a file system 31 for controlling files on an external storage device such as a hard disk through a hierarchical structure of directories, for example; a file access control list 32 for storing therein information about file sharing setup provided, for example, through an OS standard setting screen shown in FIG. 1 for each of the folders included in a predetermined drive; and a file sharing service 33 for controlling file accesses from other network connected computers (terminals). The switching device 10 directs stop and start of the file sharing service 33 based on the type of network the computer system is to be connected to, or based on a user instruction. The file sharing service 33 is referred to as “file sharing service” in Microsoft Windows and as “file sharing daemon (file sharing service daemon)” in Linux. The switching device 10 also switches enabling/disabling of setup for various programs which are automatically installed via a network.

For example, when a user having a notebook PC 50 moves to a wireless hot spot, the computer is switched to the profile for wireless locations manually or automatically. In the embodiment of the present invention, file sharing is turned off at the same time when the computer is switched to the profile, for example. File sharing is then automatically restored when moving to another location and switching the network setup. This allows the user to configure the computer to ensure security without especially caring about it.

One conventional method for turning off file sharing is to turn it off for each folder through an OS standard setting screen. Another conventional method is to turn off “Folder Sharing” listed in “Property” for each shared drive (such as Drive C, Drive D, and Drive E). These methods, however, require a tough job of checking the sharing settings of all the folders and all the drives and then individually turning off sharing for each of them. It is also very troublesome to remember original sharing settings and turn on sharing for each of them one by one in order to turn on sharing, that is, restore the original condition. The embodiment of the present invention focuses on the file sharing service 33 performing file sharing in the background and enables bi-directional control of file sharing easily, certainly and promptly by temporarily stopping the file sharing service 33 in order to turn off file sharing and releasing the temporary stop in order to turn on file sharing.

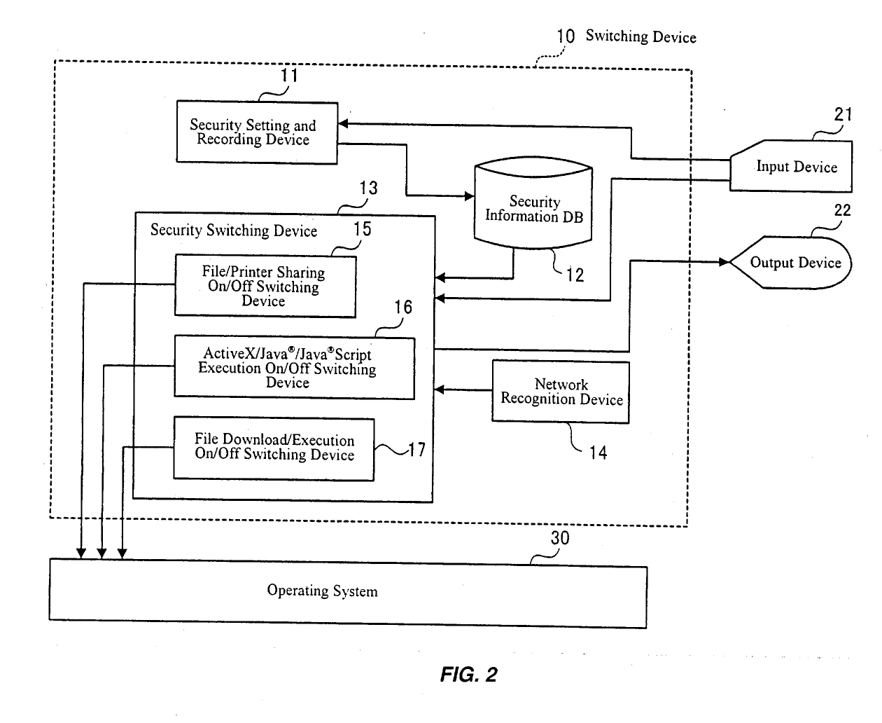

FIG. 2 is a block diagram illustrating the functions of the switching device 10. The switching device 10 operates based on various inputs from an input device 21 comprising, for example, a keyboard and a pointing device and displays, for example, switching information on an output device 22 comprising, for example, a liquid crystal display.

The switching device 10 comprises: a security setting and recording device 11 for recording various information about security setup based on a user input from the input device 21; a security information database (DB) 12 for storing the security information recorded by the security setting and recording device 11; a security switching device 13 for switching security setup for the operating system 30; and a network recognition device 14 for recognizing whether or not the network has been switched as well as the type of the network to be connected to the computer system such as the notebook PC 50. In the security information database (DB) 12, there is stored security information for each of the networks, to which the notebook PC 50 may be connected, is stored in association with, for example, each of the locations described above. For networks for which security is not ensured, such as those of wireless hot spots, security information is stored in association with each of locations such as a hotel and a hot spot so that file/printer sharing and file download/execution are turned off.

The security switching device 13 comprises: a file/printer sharing on/off switching device 15 for switching between stop (sharing disabled) and start (sharing enabled) of the file sharing service 33 of the operating system 30; an ActiveX/JavaÒ/JavaÒScript execution on/off switching device 16 provided for a browser for switching on/off of execution of ActiveX, JavaÒ and JavaÒScript; and a file download/execution on/off switching device 17 which is also provided for a browser for switching between permission and prohibition of download of various files from a network and execution thereof. In WindowsÒ, file sharing and printer sharing are identically handled in the file sharing service 33, and therefore the file/printer sharing on/off switching device 15 performs stop and start of printer sharing at the same time when performing stop and start of file sharing.

In the network recognition device 14, a network name (SSID: Service Set Identification), for example, is detected as an access point identifier using an application. The network recognition device 14 then outputs the detection result (location information, for example) to the security switching device 13 in association with the location information stored in a location profile database (not shown), for example. The location profile database is for storing various setup information, for example, for network setup in association with each location. In the network recognition device 14, the network name (SSID), for example, is obtained through scanning. The SSID is an identification number for identifying a communication counterpart. In addition to the SSID, MAC addresses may be used as the identifier to be obtained through scanning, which are used for a MAC (media access control) frame having therein fields for source and destination addresses of a fixed number of bits for identification. A detection method will be described later in detail.

The security switching device 13 obtains security information about the network from the security information database 12 based on the detection result recognized by the network recognition device 14. In the case of FIG. 2, stop and start of the file sharing service 33 of the operating system 30, and enabling and disabling of setup for various programs are switched using the file/printer sharing on/off switching device 15, the ActiveX/JavaÒ/JavaÒScript execution on/off switching device 16, and the file download/execution on/off switching device 17, based on switching information obtained from the security information database 12 in association with the location information about the location attempting network connection.

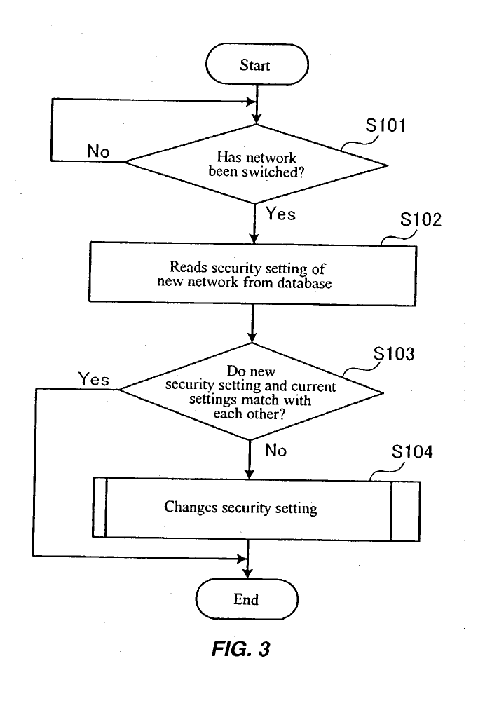

Processes executed by the switching device 10 are now described. FIG. 3 shows a flowchart illustrating a main process of switching security. In the security switching device 13, it is determined whether or not the network has been switched based on information from the network recognition device 14 (step 101). When the network has not been switched, the security switching device 13 is on standby until it is switched. When the network has been switched, it reads the security setting of the new network from the security information database 12 (step 102). It is then determined whether or not the new security setting read in and the current setting match with each other (step 103). When they match with each other, the process stops. When they do not match with each other, the security setting is changed (step 104) and the process is terminated.

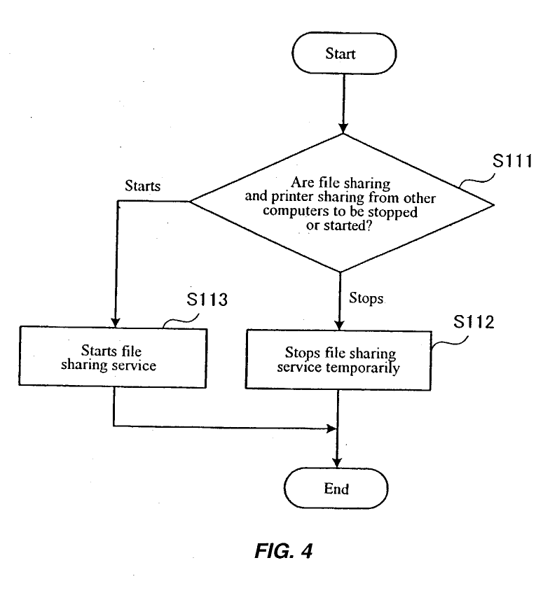

FIG. 4 shows a flowchart illustrating the process of setting up file/printer sharing in changing the security setting at step 104 shown in FIG. 3. The file/printer sharing on/off switching device 15 determines whether to stop or start file sharing and printer sharing from other computers (step 111) from information stored in the security information database 12 based on a user specification using the input device 21, for example, or based on security information related to the network recognized by the network recognition device 14, which is stored in the security information database 12. When sharing is to be stopped based on the determination, the file/printer sharing on/off switching device 15 temporarily stops the file sharing service 33 (step 112) and terminates the process. On the other hand, when it is determined that file sharing and printer sharing from other computers should be started at step 111, the file sharing service 33 is started (step 113) and the process is terminated.

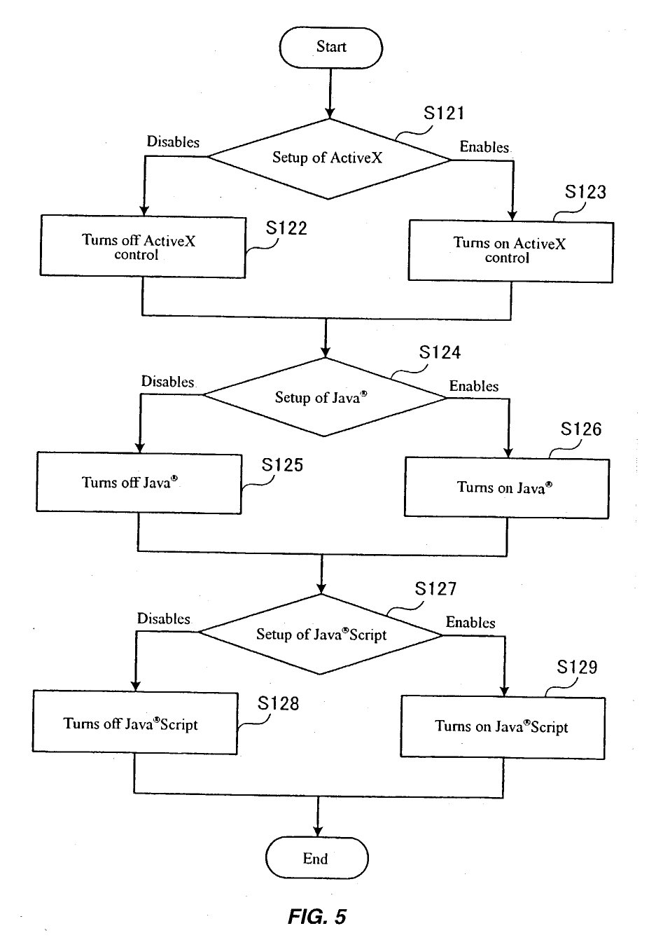

FIG. 5 shows a flowchart illustrating the process of setting up ActiveX, JavaÒ and Java Script by the ActiveX/Java/Java Script execution on/off switching device 16 in changing the security setting at step 104 shown in FIG. 3. In the ActiveX/Java /Java Script execution on/off switching device 16 provided for the browser, it is determined whether to enable or disable ActiveX based on a user specification using the input device 21, or based on security information related to the network recognized by the network recognition device 14, which is stored in the security information database 12 (step 121). To disable Active X, Active X control is turned off (step 122), and to enable Active X, Active X control is turned on (step 123). Next, determination whether to enable or disable Java is made (step 124). To disable Java, it is turned off (step 125), and to enable Java, it is turned on (step 126). Next, determination whether to enable or disable Java Script is made (step 127). To disable Java Script, it is turned off (step 128), and to enable Java Script, it is turned on (step 129). The process is then terminated.

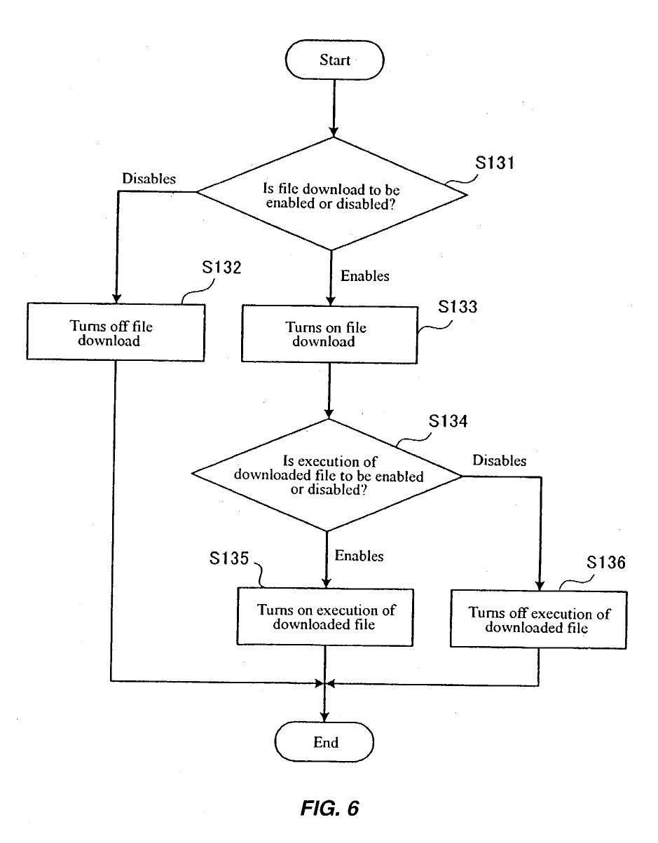

FIG. 6 shows a flowchart illustrating the process of setting up file download/execution in changing the security setting at step 104 in FIG. 3. In the file download/execution on/off switching device 17 provided for the browser, it is determined whether to enable or disable download of files to be downloaded via the network based on a user specification using the input device 21, or based on security information related to the network recognized by the network recognition device 14, which is stored in the security information database 12 (step 131). When disabling file download, it set to be turned off (step 132) and the process is terminated. When enabling file download at step 131, it is set to be turned on (step 133).

Subsequently, it is determined whether to enable or disable execution of the downloaded files based on a user specification using the input device 21, or based on security information related to the network recognized, which is stored in the security information database 12 (step 134). When enabling execution of the downloaded files, the file download/execution on/off switching device 17 turns on execution of the downloaded files (step 135) and terminates the process. When disabling execution at step 134, the file download/execution on/off switching device 17 turns off execution of the downloaded files (step 136) and terminates the process.

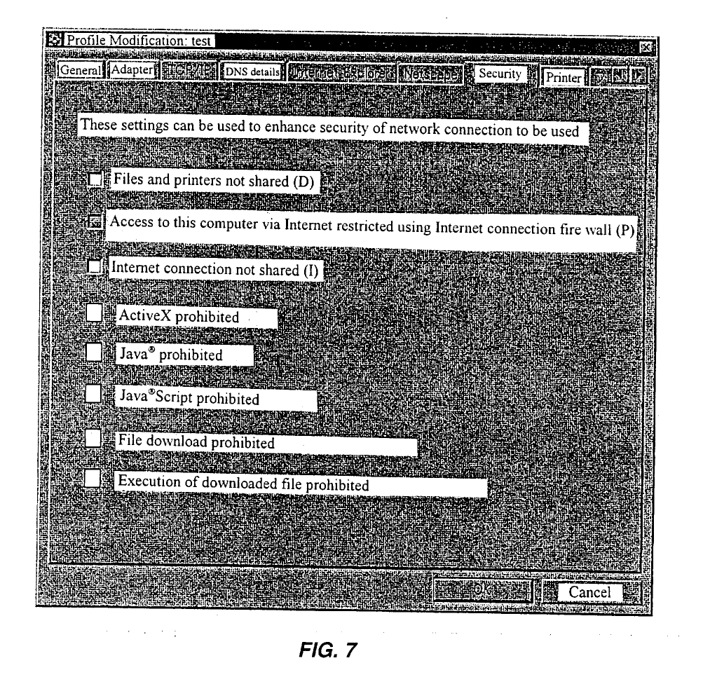

FIG. 7 shows an example of a setting screen to be displayed on the output device 22 when security is set up in the security setting and recording device 11. Security setup provided for Microsoft WindowsÒ is described here as an example. In the setup screen shown in FIG. 7, the user can make specification for enhancing security of the network connection to be used for the profile associated with the network. On this screen, the user can specify whether to enable or disable, that is, whether or not permit each of the switching processes to be executed by the file/printer sharing on/off switching device 15, the ActiveX/JavaÒ/JavaÒScript execution on/off switching device 16, and the file download/execution on/off switching device 17 in the security switching device 13. These setups can be provided for each profile of each location, and the security information set up through such a screen is stored in the security information database 12.

The network detection method (recognition method) performed by the network recognition device 14 described above is now described in more detail.

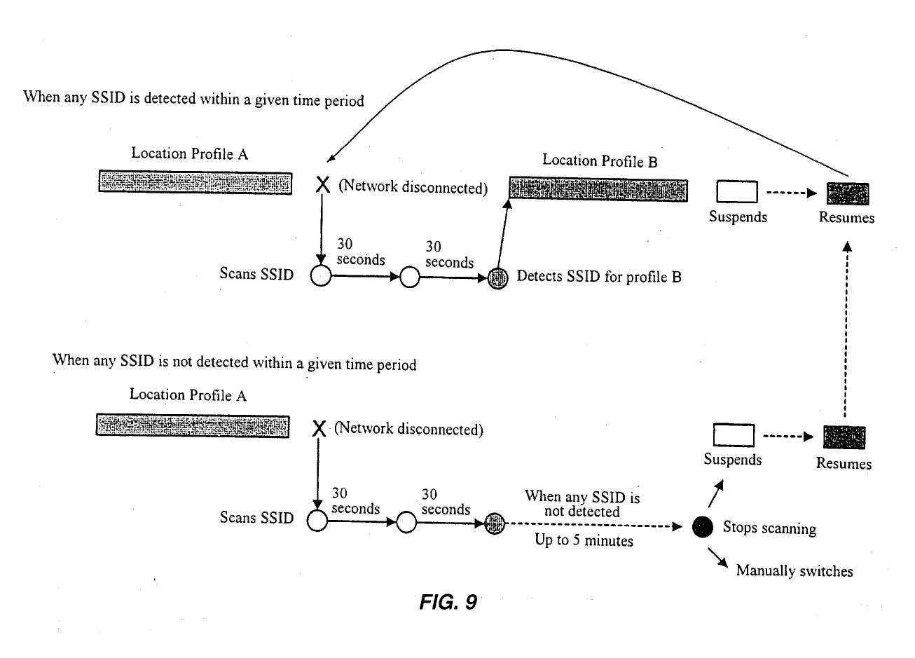

FIGS. 9(a) and (b) illustrate a network name (SSID) detection method. FIG. 9(a) shows that a SSID is detected within a given time period and FIG. 9(b) shows that the SSID is not detected within a given time period. In the case where a SSID is detected within a given time period as shown in FIG. 9(a), a user starts moving from a hot spot where he is in connection with a location profile A and therefore the network is disconnected. Network names (SSIDs) are scanned at a regular time interval (every 30 seconds, for example), and those the identifier radio wave of which are received are detected. The FIG. 9(a) shows an example where the SSID of a profile B, for example, is detected sixty seconds later. Subsequently, when the cover of the notebook PC 50 is closed, for example, while in connection with the profile B, the PC is put into a suspend mode, a power-saving mode. And then, works such as resumption of the suspended work using a resuming function are performed. After the resumption, a similar network connection detection work is performed.

On the other hand, when moving to a place where any SSID is not detected, for example, scanning is stopped after a given time period (five minutes in this case) as shown in FIG. 9(b). This suppresses battery consumption in the notebook PC 50. A user requesting connection in such a case may shift to manual switching. It is also possible to adapt the computer to attempt connection to the access point used before being suspended, as long as there exists the same named access point being used, without performing scanning immediately after the resumption, and perform the scanning described above when connection is not established, for example, in the case of moving with the notebook PC 50 while in the suspend mode within a company's premises, where the same access point can be used for connection.

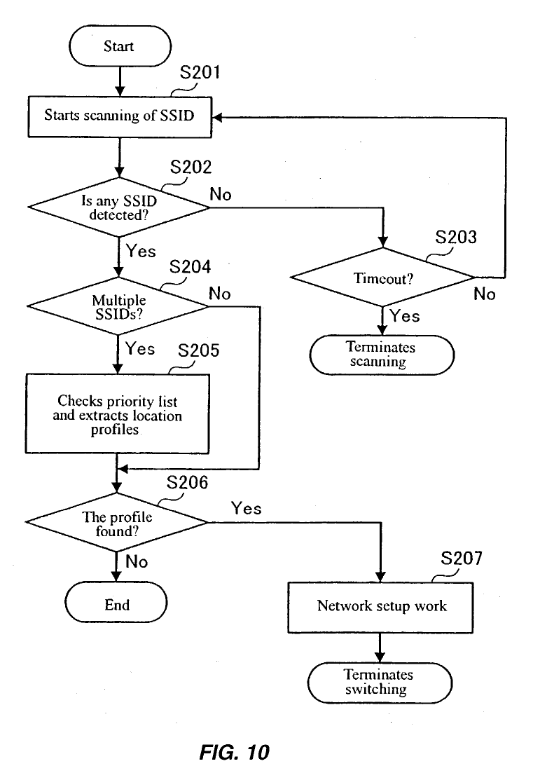

FIG. 10 shows a flowchart illustrating the process of switching location profiles. The process of switching location profiles is started by disconnection of a network and receiving of a resume event message indicating resume from suspend, for example, as described with reference to FIG. 9(a). In this case, scanning of the network names (SSIDs), which are an identifier, is started first (step 201). When no SSID is detected (step 202), it is determined whether or not time-out (5 minutes, for example) has been reached (step 203). Scanning is performed until the time-out is reached. When the time-out is reached, scanning is terminated.

When any SSID is detected at step 202, it is determined whether or not multiple SSIDs are detected (step 204). If multiple SSIDs are detected, a priority list, for example, stored in the location profile data base described above is checked to extract location profiles from the location profile DB (step 205). It is then determined whether or not the list has the profile (step 206), and the switching process terminated when it does not have the profile. When it is not multiple SSIDs that are detected at step 204, the process proceeds straight to step 206. When the list has the profile, the process proceeds to network setup work (step 207). Works such as reading in of a wireless LAN (WLAN) profile, setting up of the WLAN profile, setting up of TCP/IP (IP Helper API), and setting up of a browser (IE API) are performed here.

According to the embodiment of the present invention, as described above, a security level associated with the location is extracted from the security information database 12 shown in FIG. 2 when the network setup work is performed at step 207. The file/printer sharing on/off switching device 15 can be set to read out security information from the security information database 12 based on the location information and start the file sharing service 33 which has been temporarily stopped when moving from a hot spot to a safe location (for example, within company premises), for example.

As described above in detail, the embodiment of the present invention enables a user to use a computer apparatus without anxiety even in a place where security is not ensured, such as a wireless hot spot. File sharing is then controlled more certainly compared to the case of individually checking the sharing status of all the drives and folders to control them as is done conventionally. Switching of on/off of execution of Active X, Java and Java Script, for example, and switching of on/off of file download/execution can be performed easily and certainly. Furthermore, only by turning on sharing and execution, the original condition can be restored and bi-directional control is enabled.

In the drawings and specifications there has been set forth a preferred embodiment of the invention and, although specific terms are used, the description thus given uses terminology in a generic and descriptive sense only and not for purposes of limitation.

While the present invention has been described with respect to the embodiment of the invention, the technical scope of the present invention is not limited to the described embodiment. Various changes and modifications may be made in the described embodiment. As is apparent from the description in the appended Claims, modes of the present invention characterized by such changes and modifications are also included in the technical scope of the invention.

We claim as our invention:

1. An apparatus comprising:
a plurality of network interface devices which provide network connections;
an access control program which controls file accesses from externally connected network devices; and
a switch, coupled to said plurality of network interface devices and to said access control program, which controls external transmission via a predetermined network connection among a plurality of network connections.

2. The apparatus of claim 1, wherein said switch further comprises:
a program controller which terminates said access control program and denies file accesses from the externally connected network devices and which starts said access control program allowing accesses from the externally connected network devices.

3. The apparatus of claim 1 further comprising:
a network cognizer, coupled to said switch, which recognizes a network to be connected wherein said switch stops said access control program based on the network recognized by said network cognizer.

4. The apparatus of claim 3, further comprising:
a plurality of network profiles, wherein said network cognizer recognizes the network based on one of said plurality of network profiles.

5. The apparatus of claim 2, wherein said program controller stops said access control program based on a user specification.

6. The apparatus of claim 2, wherein said program controller starts said access control program based on a user specification.

7. An apparatus comprising:
a switch which controls external transmission via a predetermined network connection among a plurality of network connections;
a security setter and recorder which sets a security information in association with the network connection to be used and storing the security information set; and
a security switch which makes processing provided by externally connected network devices ineffective based on the security information stored by said security setter and recorder.

8. The apparatus of claim 7, wherein the processing made ineffective by said security switch is related to file/printer sharing.

9. The apparatus of claim 7, wherein the processing made ineffective by said security switch is a download of a program to be downloaded via a network.

10. The apparatus of claim 7, wherein the processing made ineffective by said security switch is a download of a program to be downloaded via a network and execution thereof.

11. An apparatus comprising:
a file sharing service which controls file accesses from externally connected network devices to a network resource individually set to be shared, wherein the network resource is selected from the group consisting of folders and drives; and
a switch which controls said file sharing service.

12. The apparatus of claim 11, wherein said switch directs the stopping of said file sharing service based on a user instruction.

13. The apparatus of claim 11, wherein said switch directs starting of said file sharing service based on a user instruction.

14. The apparatus of claim 11, wherein said switch controls said file sharing service depending on a network to be connected.

15. A Portable information equipment comprising:
a switch which enables external transmission via a network to be connected at a place to which said portable information equipment moves;
a security setter and recorder which determines how to control the sharing of resources on the network; and
a security switch which stops access to a shared network resource from an external apparatus via the network based on the setting provided by said security setter and recorder, independent of the sharing attributes of the network resource; wherein the network resource is selected from the group consisting of a folder and a drive.

16. The portable information equipment of claim 15,
wherein said security switch starts the sharing of the network resource which had previously been stopped, and
wherein said security switch performs network setting work based on detection of a network at a place to which said portable information equipment has moved, and controls the network resource sharing when performing the network setting work.

17. The portable information equipment of claim 15, wherein said security setter and recorder sets up a network profile.

18. A method comprising the steps of:
enabling an apparatus for external transmission via a predetermined network connection among a plurality of network connections;
terminating an access control program which controls file accesses from externally connected network apparatuses; and
starting execution of said stopped access control program.

19. The method of claim 18 wherein said terminating step is based an event, wherein the event is selected from the group consisting of a user setting and an automatic action, independent of the sharing attributes of each of a set of individual drives and folders, to prohibit file sharing with said other apparatuses.

20. The method of claim 18 wherein said starting execution step permits file sharing with the other apparatuses, which had been stopped, based on a preset sharing setup without performing new sharing setup for a network resource selected from the group consisting of folders and drives.

21. A method comprising the steps of:
enabling external transmission via a predetermined network connection among a plurality of network connections on an apparatus;
setting security information in association with a network connection to be used;
storing the set security information; and
disabling processes to be performed by externally connected network apparatuses based on the stored security information during the setting step.

22. The method of claim 21, wherein said disabling step is for disabling processes related to one of a group consisting of sharing of files and printers, and processes related to a program to be downloaded via a network.

23. A program product comprising:
a computer usable medium having computer readable program code embodied therein for causing a computer to enable external transmission via a predetermined network connection among a plurality of network connections, the computer readable program code in said program product implementing functions effective to:
terminate an access control program for controlling file accesses from externally connected network computers; and
start execution of said stopped access control program.

25. A program product comprising:
a computer usable medium having computer readable program code embodied therein for causing a computer to enable external transmission via a predetermined network connection among plurality of network connections, the computer readable program code in said program product implementing functions effective to:
set security information in association with a network connection to be used;
store said security information in a predetermined memory; and
making processing provided by externally connected network computers ineffective based on the stored security information.
